(19) United States
(12) Patent Application Publication
(10) Pub. No.: US 2015/0158464 A1
(43) Pub. Date: Jun. 11, 2015

(54) JACK WITH SELF-LOCATING ENGAGEMENT DEVICE

(71) Applicant: Cequent Performance Products, Inc., Plymouth, MI (US)

(72) Inventor: Erik Alanko, Wausau, WI (US)

(21) Appl. No.: 14/561,406

(22) Filed: Dec. 5, 2014

Related U.S. Application Data
(60) Provisional application No. 61/913,058, filed on Dec. 6, 2013.

(51) Int. Cl. B60S 9/04

(52) U.S. Cl. CPC B60S 9/04

(57) ABSTRACT

A jack is shown and described. The jack may include a first tube member, a second tube member telescopingly engaged with the first tube member, the second tube member including at least one aperture, and a drop leg telescopingly engaged with the second tube member. The jack may also include an engagement device operatively coupled with the second tube member, the engagement device including a pin member and a self-locating device, where the self-locating device generally aligns the pin member with the at least one aperture of the second tube member.

### CROSS-REFERENCE TO RELATED APPLICATION

This application claims benefit from U.S. Provisional Patent Application No. 61/913,058, entitled “Jack with Self-Locating Engagement Device,” filed on Dec. 6, 2013, which is hereby incorporated in its entirety by reference.

### FIELD OF THE INVENTION

The present invention is generally related to a jack with a self-locating engagement device and, more particularly, to a jack having a drop leg and a self-locating engagement device to operatively align a pin assembly with an inner tube.

### BACKGROUND

Jacks are often used in association with towed vehicles, such as trailers. Jacks may be used for many different functions in association with towed vehicles, including, without limitation, holding the towed vehicles in place when not connected to towing vehicles, appropriately positioning towed vehicles to operatively connect with towing vehicles, storing towed vehicles or any such similar situations.

It is often desirable to quickly provide elongation of the jack during operation. Jacks may, therefore, include a drop leg where there is no mechanical cranking required to achieve significant jack elongation or contraction in a short amount of time. This may be particularly useful at the beginning or completion of the lifting process of the jack.

Jacks are commonly used with trailers such as A-frame trailers. The A-frame trailers commonly include a coupler to which the applicable jack attaches. These couplers include an aperture, such as a generally round aperture (although same may be square or rectangular), through which the outer tube of the jack may pass. The size and shape of the aperture typically match the size of the outer tube of the jack so that there is only enough room for the outer tube jack to pass through the aperture from the top side of the coupler. The aperture is typically not large enough for a drop leg to be passed therethrough. Therefore, if a drop leg is desired to be used with the jack, it is operatively engaged with the jack after the jack—or more specifically, the outer tube of the jack—has passed through the aperture of the coupler. The aperture in the coupler and the jack are usually generally round, which may prevent the larger portions of the drop leg from being inserted therethrough.

Drop legs are typically engaged with an inner tube of a jack. The drop leg engages with the inner tube through use of a lynch pin. In such situations, a user adjusts the drop leg by unclasping and removing the lynch pin from the drop leg and inner tube. The user may then position the height of the drop leg to the applicable height. Then, the user must re-insert the lynch pin into the drop leg and inner tube. The user must ensure that the drop leg and inner tube are in operative positions relative to one another to ensure proper engagement with the lynch pin. This can be very inconvenient for the user. The user typically must bend down toward the ground the accomplish all of this; especially in those situations in which the jack has already been inserted through the aperture of the coupler as described above.

Therefore, there is a need for an engagement device to operatively engage the drop leg with the inner tube of the jack that is convenient for the user—especially when used with a round jack. There is a need for an engagement device that is self-locating. There is further a need for an engagement device to be biased to assist the user with operation.

### SUMMARY

A jack is shown and described. The jack may include a first tube member, a second tube member telescopingly engaged with the first tube member, the second tube member including at least one aperture, and a drop leg telescopingly engaged with the second tube member. The jack may also include an engagement device operatively coupled with the second tube member, the engagement device including a pin member and a self-locating device, where the self-locating device generally aligns the pin member with the at least one aperture of the second tube member.

A jack may include a pair of telescoping tubular members, at least one of the pair of telescoping tubular members including at least one aperture, a drop leg telescopingly engaged with the at least one of the pair of telescoping tubular members, and an engagement device selectively attached with the drop leg. The engagement device may include a pin assembly selectively engageable with the drop leg and a self-locating device that generally aligns the pin assembly with the at least one aperture of the at least one of the pair of telescoping tubular members.

A jack may include a first tube member, a second tube member telescopingly engaged with the first tube member, the second tube member including at least one aperture, a drop leg telescopingly engaged with the second tube member, and an engagement device. The engagement device may include a pin member axially positionable to engage the at least one aperture of the second tube member and a strap selectively engaged with the drop leg, the strap including a self-locating device engageable with the drop leg to operatively position the pin member with respect to the at least one aperture.

A jack may include a pair of telescoping tubular members, at least one of the pair of telescoping tubular members including at least one aperture, a drop leg telescopingly engaged with the at least one of the pair of telescoping tubular members, the drop leg including at least one drop leg aperture, and an engagement device engaged with the drop leg. The engagement device may include a pin member axially positionable from an engaged position to a disengaged position, and a strap engaged with the drop leg, the strap holding the pin member when the pin member is in the disengaged position.

### BRIEF DESCRIPTION OF THE DRAWINGS

Operation of the invention may be better understood by reference to the following detailed description taken in connection with the following illustrations, wherein:

FIG. 1 is a perspective view of an embodiment of a jack with a drop leg and engagement device in a locked position.

FIG. 2 is an exploded view of the jack with drop leg and engagement device.

FIG. 3 is an exploded view of the jack with drop leg and engagement device.

FIG. 4 is a cross-sectional view of jack with drop leg and engagement device.

FIG. 5 is a cross-sectional view of a pin assembly of an engagement device for a jack with drop leg.

FIG. 6 is a side view of a pin member of an engagement device for a jack with drop leg.

FIG. 7 is a perspective view of a motorized jack being inserted into a coupler of a trailer, the jack having a drop leg and engagement device.

FIG. 8 is a perspective view of a jack being inserted into a coupler of a trailer, the jack having a drop leg and engagement device.

FIG. 9 is a side view of a portion of a jack with drop leg and engagement device.

FIG. 10 is a rear view of a portion of the jack with drop leg and engagement device of FIG. 9.

FIG. 11 is a cross-sectional view of a portion of the jack with drop leg and engagement device of FIG. 9 in an engaged position.

FIG. 12 is a cross-sectional view of a portion of the jack with drop leg and engagement device of FIG. 9 in a disengaged position.

FIG. 13 is a bottom view of the engagement device.

FIG. 14 is a rear view of the engagement device of FIG. 13.

FIG. 15 is a top view of the engagement device of FIG. 13.

FIG. 16 is a top view of an engagement device.

FIG. 17 is atop view of a non-round alternative of an engagement device.

FIG. 18 is a bottom view of an engagement device.

FIG. 19 is a side view of the engagement device of FIG. 18.

FIG. 20 is a top view of the engagement device of FIG. 18.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

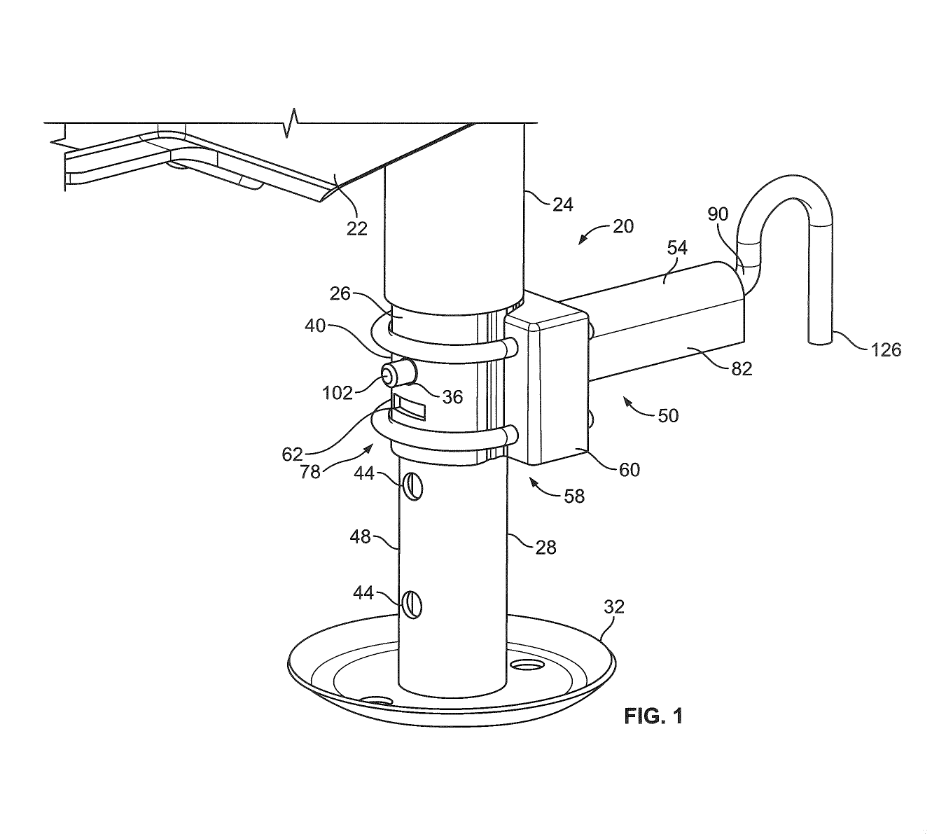

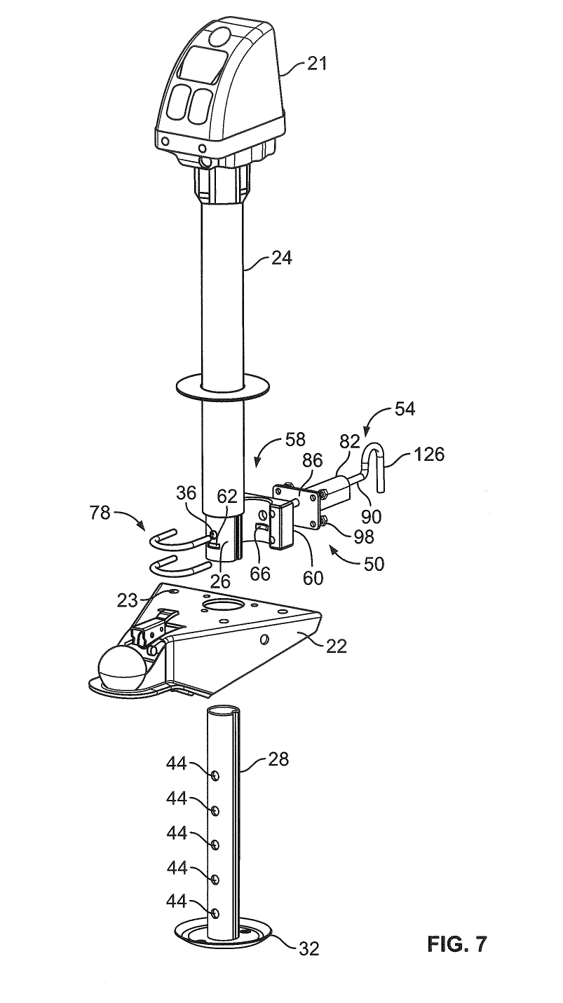

A jack 20 is shown in FIGS. 1-4. The jack 20 may be any appropriate type of jack, such as by way of a non-limiting example, a mechanical jack, screw jack, motorized jack or any combination of such or any other type of jack. The present teachings are not limited to a specific type of jack and may be applied to any appropriate type of jack. As shown in FIG. 7 and by way of a non-limiting example, the jack 20 may include an electric motor 21 to operate the jack 20. The jack 20 may be operatively coupled to a towed vehicle 22 in any appropriate manner. By way of a non-limiting example, the jack 20 may be operatively attached with a coupler 22 of a trailer (not shown).

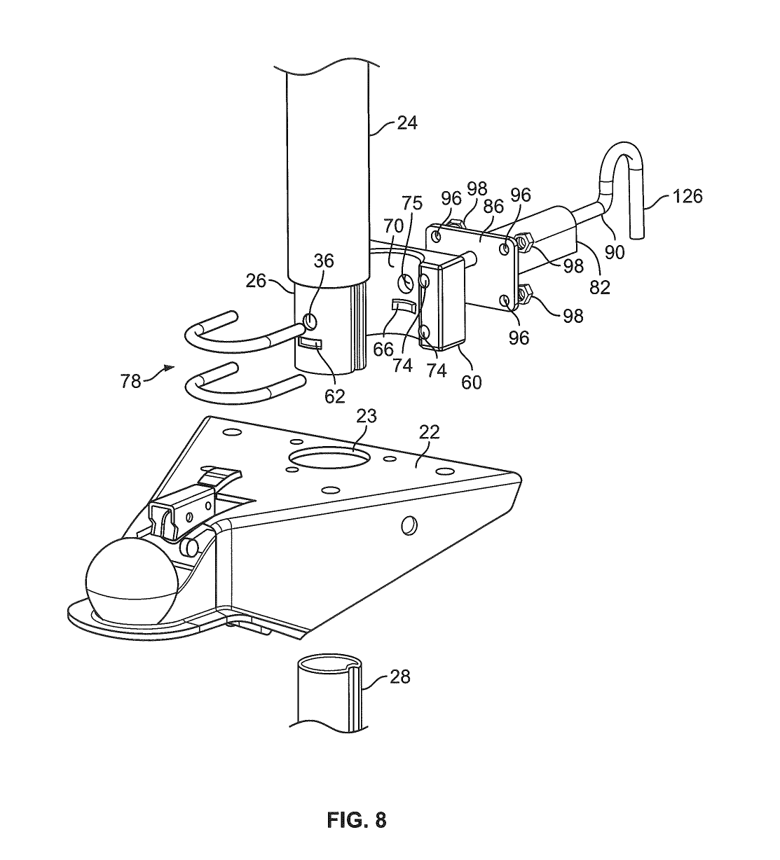

The coupler 22 may include an aperture 23—as shown in FIGS. 7 and 8—through which the jack 20 may be operatively passed. The aperture 23 may be of a generally round shape and may be of a size that is similar to the size of an outer diameter of the jack 20, which is described in more detail below. However, the aperture 23 is not limited to being round. It may also be rectangular, square or any other appropriate shape.

The jack 20 may include an outer housing or tube 24, an inner housing or tube 26, and a drop leg 28. The outer and inner tubes 24, 26 may be of any appropriate shape, such as by way of a non-limiting example, a generally round cross-sectional shape. The present teachings, however, are not limited to this configuration. In some embodiments, the outer and inner tubes 24, 26 may have a generally square, rectangular or other appropriate shape. The inner tube 26 may be in a telescoping relationship with or otherwise telescopingly engaged with the outer tube 24. By way of a non-limiting example, the inner tube 26 may retract within or extend from the outer tube 24. Likewise, the drop leg 28 may be of any appropriate shape, such as by way of a non-limiting example, a generally round cross-sectional shape. The drop leg 28 may be in telescoping relationship with or otherwise telescopingly engaged with the inner tube 26. By way of a non-limiting example, the drop leg 28 may retract within and extend from the inner tube 26.

The outer tube 24 may be of a generally round cross-sectional shape. The outer tube 24 may have an outer diameter that is generally similar to the diameter of the aperture 23 in the coupler 22. The outer diameter of the outer tube 24 may be of a shape and size that it is configured to be insertable within and through the aperture 23 in the coupler 22. The fit between the outer tube 24 and aperture 23 is generally tight such that the aperture 23 is just large enough to allow the outer tube 24 to pass therethrough, and not the drop leg 28.

The drop leg 28 may be secured to and supported by a base 32 of any appropriate shape. The base 32 may be attached to the drop leg 28 in any appropriate manner, such as by way of a non-limiting example, welding, fastening, using adhesives, or the like. The base 32 may be a generally planar plate that may be shaped and sized to allow the jack 20 to freely stand when placed on a surface such as the ground. In some embodiments, the base 32 may be of any appropriate shape, such as generally square, rectangular, circular, oval, or the like, so as that it may generally add stability to the jack 20. More specifically, the base 32 may be shaped and sized such that the jack 20 may generally remain in an upright position without having to otherwise be supported by an item. Moreover, the base 32 may distribute load carried by the jack 20 to a substantially large contact area with the ground or any other appropriate surface. The base 32 may be of a larger size than the aperture 23 in the coupler 22, which may prevent the drop leg 28 from being engaged with the inner tube 26 before insertion of the outer tube 24 through the aperture 23 in the coupler 22.

The jack 20 may include a crank assembly (not shown), which may be used in a conventional manner to raise and lower the inner tube 26 relative to the outer tube 24. This may result in the jack 20 being selectively positionable, i.e., extendable and retractable, so that the jack 20 may operate as necessary. In some embodiments, the crank assembly may be a sidewind crank assembly. In other embodiments, the crank assembly may be any other appropriate type of crank assembly, such as for example, a topwind crank, generally employing any appropriate gearing mechanism. The present teachings, however, are not limited to a particular gearing mechanism and any appropriate gearing mechanism may be used without departing from the present teachings.

The inner tube 26 may include a pair of apertures 36 on opposing sides 40 of the inner tube 26. The apertures 36 may be aligned on each side 40 of the inner tube 26 such that the apertures 36 may extend through the inner tube 26. While a pair of apertures 36 is shown, the inner tube 26 may include more than the pair of apertures 36. In some embodiments, a plurality of pairs of apertures 36 may be positioned along an entire length or a portion of the length of the inner tube 26. Still further, the apertures 36 may be positioned on any appropriate portion of the inner tube 26 and are not limited to be on the sides 40 or limited to be opposed one another.

The drop leg 28 may include a plurality of apertures 44. The apertures 44 may be positioned on opposing sides 48 of the drop leg 28 and may be positioned along an entire length or portion of the length of the drop leg 28. By way of a non-limiting example, the apertures 44 may be positioned as pairs on opposing sides 48 of the drop leg 28 and may be positioned at predetermined locations along the length of the drop leg 28. Further, by way of a non-limiting example, four pairs of such apertures 44 may be included along a portion of the length of the drop leg 28.

The drop leg 28 may be selectively positioned relative to the inner tube 26 such that one of the pair of apertures 44 of the drop leg 28 may generally align with the pair of apertures 36 of the inner tube 26. In such embodiments, the drop leg 28 may be telescopingly positioned relative to the inner tube 26 to generally align the apertures 36 and 44 as required to position the drop leg 28 appropriately.

The jack 20 may further include an engagement device 50 that selectively and operatively engages the drop leg 28 with the inner tube 26 to lock the drop leg 28 in an operative position relative to the inner tube 26. The engagement device 50 may include a pin assembly 54 and a self-locating device 58 of any appropriate configuration. As shown, the pin assembly 54 may be operatively coupled with the self-locating device 58.

As shown and by way of an exemplary embodiment, the self-locating device 58 may include mating engagement members 59 and an attachment member 60. The mating engagement members 59 may include, without limitation a first engagement member 62 attached with or formed in the inner tube 26 and a second engagement member 66 attached with or formed in the attachment member 60. The first engagement member 62 may be of any configuration and may be positioned in any appropriate location, including, without limitation on the opposing sides 40 of the inner tube 26. By way of a non-limiting example, the first engagement member 62 may be an aperture or slot formed in the inner tube 26 of any appropriate shape and size. As shown in FIGS. 1-3, the first engagement member 62 may be of a generally rectangular shape, but may be of any appropriate shape, including, without limitation, circular, non-circular, square, polygonal, triangular, oval or a combination of such.

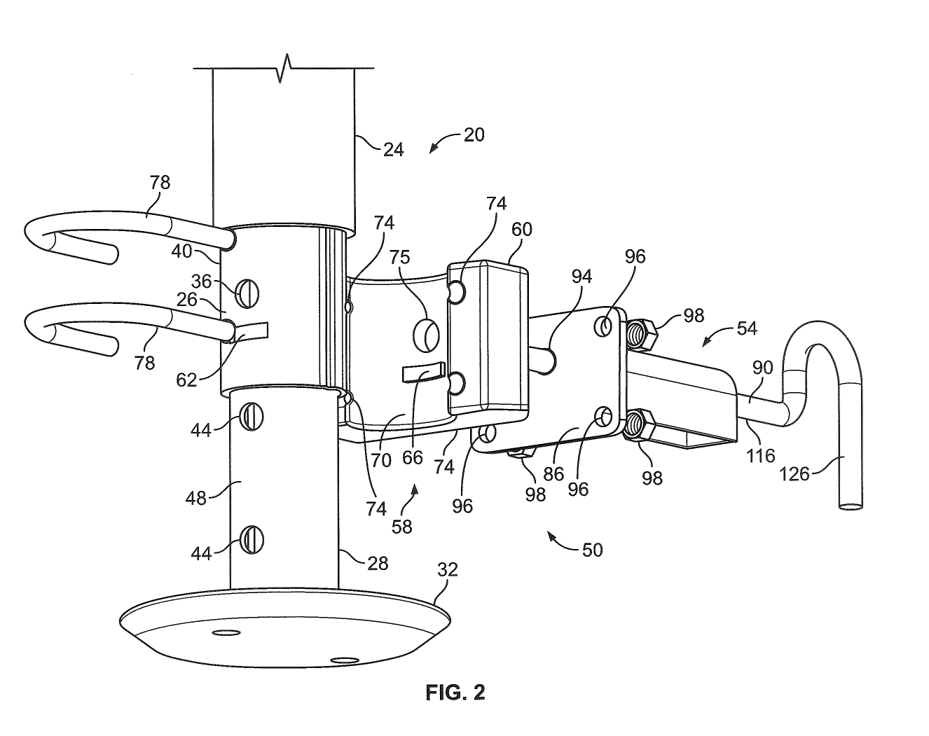

The second engagement member 66 may be of any configuration. By way of a non-limiting example, the second engagement member 66 may be a tab or protruding member formed in or attached with the attachment member 60 and may be of any appropriate shape and size. As shown in FIG. 2, the first second member 66 may be of a generally rectangular shape, but may be of any appropriate shape, including, without limitation, circular, non-circular, square, polygonal, triangular, oval or a combination of such.

The first and second engagement members 62, 66 may be of mating/corresponding shapes and sizes such that they may operatively mate or engage with one another. It should be understood, however, that the first and second engagement members 62, 66 may be of any appropriate shape and size and are not limited to that shown and described. In some embodiments, the first engagement member 62 may be a female member and the second engagement member 66 may be a male engagement member, such as shown in the drawings. In some embodiments, the first engagement member 62 may be a male member and the second engagement member 66 may be a female member such that the first and second engagement members 62, 66 are operatively engageable.

Further, the first and second engagement members 62, 66 may be of a shape and size different from that of the apertures 36, 44. This may allow a user to distinguish the first and second engagement members 62, 66 from the apertures 36, 44 in the inner tube 26 and drop leg 28. However, in some embodiments, the first and second engagement members 62, 66 may be of substantially the same shape and sizes as the apertures 36, 44.

The attachment member 60 may be of any appropriate configuration and is not limited to that shown and described. The attachment member 60 may be a steel casting, stamped steel or any appropriate material. The attachment member 60 may include an inner tube engagement portion 70 of a shape that may generally correspond to the outer diameter of the inner tube 26. In some embodiments, the second engagement member 60 may be positioned on the inner tube engagement portion 70. The attachment member 60 may be operatively coupled with the inner tube 26 in any appropriate manner. As shown, the attachment member 60 may include two pairs of apertures 74 and a generally centrally located aperture 75. The aperture 75 may be positioned on the attachment member 60 in any appropriate position and is not limited to that shown and described. The aperture 75 may be of a shape and size such that a portion of the pin assembly 54 may engage the aperture 75 as described in more detail below. The apertures 74 may be of any appropriate shape and positioned at any appropriate location on the attachment member 60.

An attachment device 78 of any appropriate configuration may be utilized to operatively couple the attachment member 60 with the inner tube 26. The attachment device 78 may include a pair of U-bolts 78 configured to be inserted into and through the apertures 74 of the attachment member 60. While a pair of U-bolts 78 are shown and described, the attachment device 78 is not limited to this configuration. By way of a non-limiting example, the attachment device 78 may include two pair of bolts, a single stamped steel strap, a plurality of stamped steel strap, a strap, a plurality of straps, or any appropriately configured attachment device.

The attachment device 78 may operatively couple the pin assembly 54 with the attachment member 60 and the inner tube 26. The pin assembly 54 may include a first generally hollow housing member 82, an engaging plate 86 attached with the housing member 82, and a pin member 90. The engaging plate 86 may by attached with the housing member 82 in any appropriate manner, such as being welded, adhered or fastened. In some embodiments, the engaging plate 86 may be monolithically formed with the housing member 82. The housing member 82 may be monolithically formed or may be formed through attaching separate components. The housing member 82 may include an open bottom portion, a closed bottom portion or a partially open/closed bottom portion. The present teachings are not limited to the configuration shown and described. Any appropriate configuration of the housing member 82 may be utilized.

The engaging plate 86 may include an aperture 94 configured such that the pin member 90 may extend through the aperture 94 as described in more detail below. The engaging plate 86 may include two pairs of apertures 96 of any appropriate configuration. The apertures 96 may be of any appropriate shape and positioned at any appropriate location on the engaging plate 86. The attachment device 78 may be utilized to operatively couple the engaging plate 86—and in turn the pin assembly 54—with the inner tube 26. As shown the attachment member 60 may be generally positioned between the pin assembly 54 and the inner tube 26. By way of a non-limiting example, the pair of U-bolts 78 may be configured to be inserted into and through the apertures 94 of the engaging plate 86. Two pairs of nuts 98 may be operatively secured with the U-bolts 78 to operatively secure the pin assembly 54 and the self-locating device 58, i.e., the engagement device 50, with the inner tube 26.

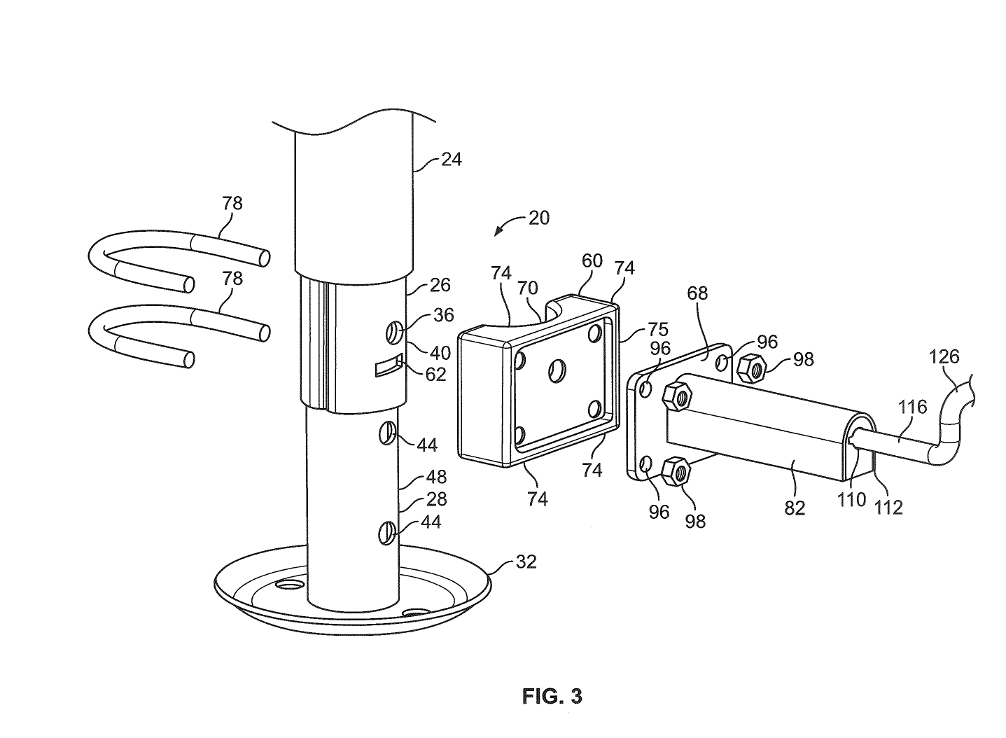

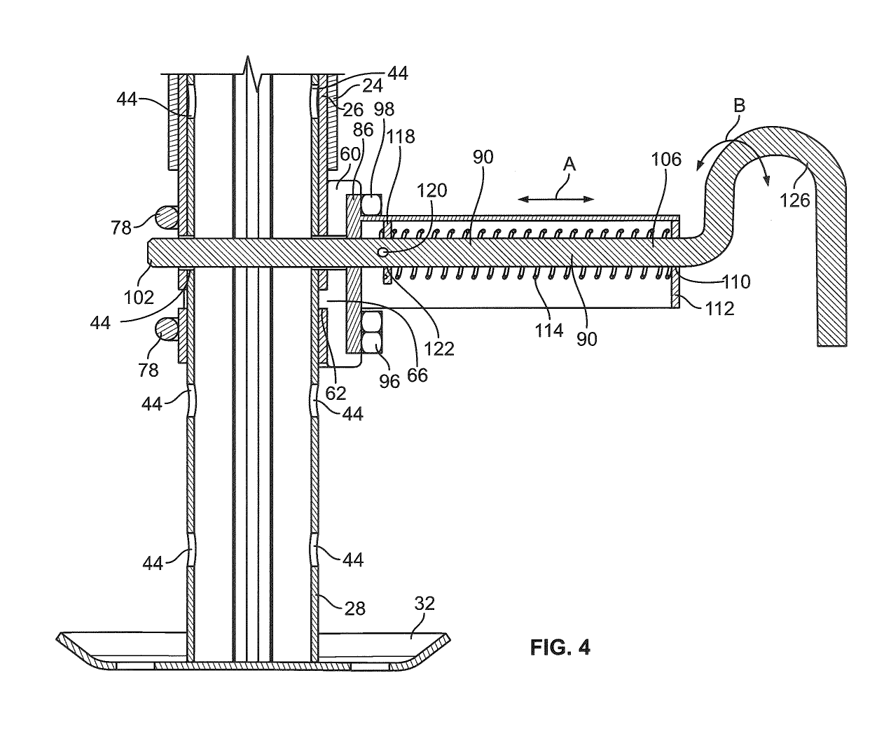

The pin member 90 may be generally positioned within the housing member 82 such that portions of the pin member 90 may extend out from the housing member 82 in at least two directions. As shown in FIG. 4, a first portion 102 of the pin member 90 may extend at one direction from the aperture 94 of the engaging plate 86. The aperture 94 may be of a diameter d₁ that is generally larger than an outer diameter d₂ of the first portion 102 of the pin member 90 such that the first portion 102 of the pin member 90 may be inserted into and out of the aperture 94. Further, the first portion 102 may be of a shape and size such that it is selectively and axially positionable into and out of the apertures 36 and 44 of the inner tube 26 and drop leg 28 as described in more detail below.

A second portion 106 of the pin member 90 may extend from the housing member 82. The second portion 106 may be opposite the first portion 102. As shown, the housing member 82 may include an aperture 110 at an end portion 112 from which the second portion 106 of the pin member 90 may extend. The aperture 110 may be of a shape and size such that the second end portion 110 of the pin member 90 may be selectively positioned into and out of the aperture 110. Further, the pin member 90 may be of a shape and size such that it may engage aperture 75 and may be axially positioned therein.

The pin assembly 54 may be biased by a biasing member 114 of any appropriate configuration. The biasing member 114 may be operatively engaged with the pin member 90 and may be generally positioned within the housing member 82. The biasing member 114 may include a coiled spring, helical spring, compression spring or the like that generally circumscribes the pin member 90 as shown in FIG. 4, i.e., the biasing member 114 may telescopingly engage the pin member 90. While the biasing member 114 is shown as a coiled spring circumscribing the pin member 90, the biasing member 114 may be of any configuration and is not limited to that shown and described herein. In some embodiments, the biasing member 114 may bias the pin member 90 toward the inner tube 26 whereby the pin member 90 may engage the apertures 36, 44 of the inner tube 26 and drop leg 28, respectively.

The pin assembly 54 may include a washer 118 that may be attached with the pin member 90. The washer 118 may be of any appropriate configuration and may be attached with the pin member 90 in any appropriate manner, including, without limitation, being fastened, welded, adhered or being monolithically formed therewith. By way of a non-limiting example, a pin 120 may be inserted into the pin member 90, such as through an aperture formed therein, and may engage the washer 118 to position and maintain the washer 118 in an operative position. The washer 118 may include an aperture 122 through which the pin member 90 may pass. The biasing member 114 may be positioned generally between the washer 118 and the end portion 112 of the housing member 82. The distance between the washer 118 and end portion 112 of the housing member 82 may allow the biasing member 114 to be in a generally or partially uncompressed state, i.e., the biasing member 114 biases the pin member 90 toward the inner tube 26 whereby the pin member 90 may engage the apertures 36, 44 of the inner tube 26 and drop leg 28, respectively.

The second end portion 106 of the pin member 90 may include a handle 126. The handle 126 may be of any appropriate shape and size. The handle 126 may assist the user in grasping the pin member 90 in order to operate the pin assembly 54. Specifically, the handle 126 may be of a configuration to permit the user to grasp the pin member 90 to axially position the pin member 90 to and from an engaged and disengaged position. By way of a non-limiting example, the user may grasp the handle 126 and axially and selectively position the pin member 90. The biasing member 114 may be configured to bias the pin member 90 toward the engaged position. The handle 126 may allow the user to overcome this biasing force and axially pull—such as shown by arrow A in FIG. 4—the pin member 90 until the first portion 102 of the pin member 90 exits the apertures 36 and 44 of the inner tube 26 and drop leg 28.

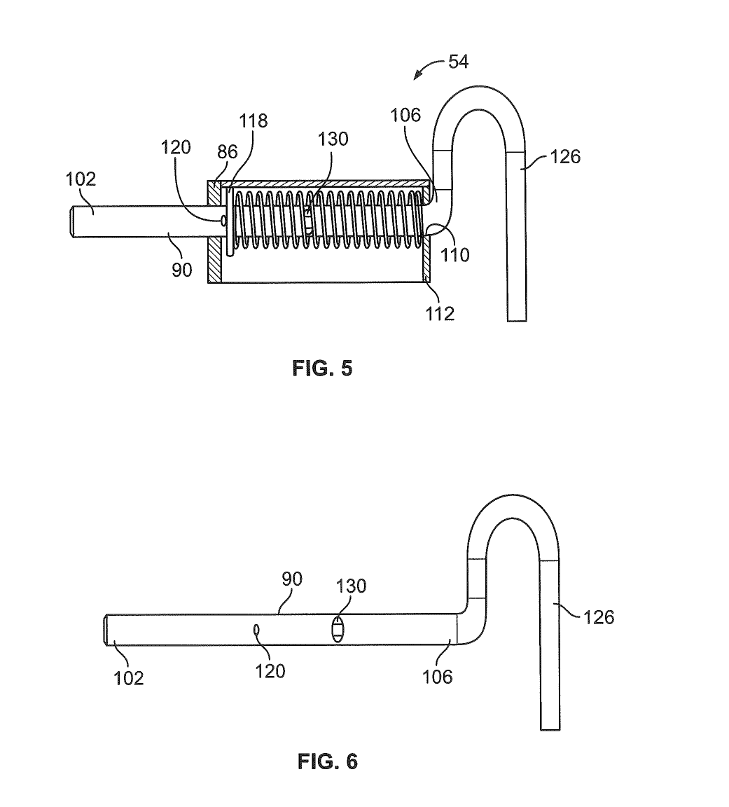

The pin member 90 may further include a locking member 130 that extends from the pin member 90 as shown in more detail in FIGS. 5 and 6. The locking member 130 may be of any appropriate configuration and may be formed in any appropriate manner. By way of a non-limiting example, the locking member 130 may include a pin inserted into the pin member 90. The pin 130 may be squashed or crushed to form a nub or protrusion that extends from the pin member 90. However, the locking member 130 may be formed in any other appropriate manner. Further, the pin member 90 may include any appropriate number of locking members 130, e.g., one, two, three, etc. The locking member(s) 130 may be configured to engage the housing member 82 to hold the pin assembly 54 in the disengaged position, i.e., with the first portion 102 of the pin member 90 out of the apertures 36, 44 of the inner tube 26 and drop leg 28. Further, the locking member(s) 130 may be configured to hold the pin assembly 54 in the engaged position, i.e., with the first portion 102 of the pin member 90 in the apertures 36, 44 of the inner tube 26 and drop leg 28.

In some embodiments, the aperture 110 may be of a shape and size such that the locking member 130 may pass therethrough in a first position and may otherwise engage the end portion 112 of the housing member 82 when the locking member 130 is in at least a second position. The locking member 130 may be positioned between the first and second positions by rotating the pin member 90. In such embodiments, the user may rotate the handle 126 an appropriate amount (e.g., 90 or 180 degrees), such as shown in FIG. 4 by arrow B. The amount of rotation may depend upon the number of locking members 130 utilized and the position of such relative to the pin member 90. As the handle 126 is rotated, the pin member 90 rotates and the locking member 130 similarly rotates. The locking member 130 may then be positioned relative to the aperture 110 such that the locking member 130 may pass through the aperture 110. This may allow the pin member 90 to be selectively and axially positioned to the engaged position, such as shown in FIG. 1.

In operation, the user may insert the outer tube 24 into and through the aperture 23 in the coupler 22. As noted above, the outer tube 24 may have a generally round cross-sectional shape that generally matches the shape and size of the aperture 23 in the coupler 22. This may provide a tight fit such that the drop leg 28 is required to be attached after the outer tube 24 is inserted into and through the aperture 23 of the coupler 22, e.g., the base 32 is too large to fit through the aperture 23. Once inserted through the aperture 23 of the coupler 22, the drop leg 28 may be telescopingly inserted into the inner tube 26. The cross-sectional shape of the inner tube 26 and drop leg 28 may be generally round.

The user may then attach the engagement device 50. By way of a non-limiting example, the user may position the attachment member 60 adjacent an end portion of the inner tube 26. The inner tube engagement portion 70 may be of a shape and size to engage with the round outer diameter of the inner tube 26. The pin assembly 54 may be positioned adjacent the attachment member 60. Specifically, the engaging plate 86 may be positioned adjacent to the attachment member 60 such that the apertures 74 and 96 are generally aligned. The attachment device 78 may be inserted into and through the aligned apertures 74 and 96.

The attachment member 60 may be operatively aligned with the inner tube 26 through use of the self-locating device 58. The self-locating device 58 may ensure operative positioning of the engagement device 50 with the inner tube 26 and drop leg 28. By way of a non-limiting example, the first and second engagement members 62, 66 may be generally aligned and then inserted or otherwise matingly engaged with one another. Engaging the first and second engagement members 62, 66 may generally align the attachment member 60 in an operative position relative to the inner tube 26. As the pin assembly 54 is operatively coupled with the attachment member 60, the pin assembly 54 may be operatively aligned and positioned with respect to the inner tube 26. This may result in the pin member 90 being operatively engaged with the inner tube 26 and drop leg 28. Specifically, the pin member 90 may be operatively aligned with and insertable into and out of the apertures 36 and 44 of the inner tube 26 and drop leg 28. Once in this position, the pin member 90 may be selectively engaged with and disengaged from the apertures 36 and 44.

Upon alignment of the first and second engagement members 62, 66 the nuts 98 may then be operatively engaged with the attachment device 78 securing the pin assembly 54 and the attachment member 60 with the inner tube 26.

The pin member 90 may be selectively engaged with and disengaged with the apertures 36 and 44. Specifically, the drop leg 28 may be telescopingly moved into and/or out of the inner tube 26 until it is in its operative position, e.g., until the base 32 engages the ground. Once in this position, the handle 126 may be rotated—as shown by arrow B in FIG. 4—and the locking member 130 may disengage from the end portion 112 of the housing member 82 so that it may enter through aperture 110. As the pin member 90 is under tension from the biasing member 114, the pin member 90 may axially move toward the inner tube 26—such movement may be accomplished without human intervention as the biasing of the biasing member 114 may force the pin member 90 toward the inner tube 26. The first portion 102 of the pin member 90 may enter into the apertures 36 and 44. This thereby may allow jack 20 to support a load with drop leg 28 axially fixed relative to inner tube 26.

The drop leg 28 may be disengaged from the inner tube 26 so that it may be positioned axially relative to the inner tube 26 by disengaging the engagement device 50. In such embodiments, the handle 126 may be axially/linearly positioned—such as shown by arrow A in FIG. 4—under the bias of the biasing member 114. As the handle 126 is axially positioned, the pin member 90 may be axially positioned under the bias of the biasing member 114. The first portion 102 of the pin member 90 may be axially positioned out of engagement with the apertures 36 and 44 of the inner tube 26 and drop leg 28. Upon such axial movement, the locking member 130 may pass through and out of the aperture 110. The handle 126 may be rotated until the locking member 130 engages with the end portion 112 of the housing member 82 generally preventing the pin member 90 from biasing back toward the inner tube 26 despite being biased by the biasing member 114 toward the inner tube 26. The drop leg 28 may be operatively positioned or removed from the inner tube 26. The handle 126 may be rotated and the biasing from the biasing member 114 may axially move the pin member 90, or more specifically, the first portion 102 thereof into the apertures 36 and 44 engaging the drop leg 28 with the inner tube 26.

Additional embodiments of the jack according the present teachings are described below. In the descriptions, all of the details and components may not be fully described or shown. Rather, the features or components are described and, in some instances, differences with the above-described embodiments may be pointed out. Moreover, it should be appreciated that these other embodiments may include elements or components utilized in the above-described embodiments although not shown or described. Thus, the descriptions of these other embodiments are merely exemplary and not all-inclusive nor exclusive. Moreover, it should be appreciated that the features, components, elements and functionalities of the various embodiments may be combined or altered to achieve a desired jack without departing from the spirit and scope of the present invention.

In some embodiments, the jack 20 may not include the attachment member 60. In such embodiments, the pin assembly 54 may include the second engagement member 66 such that the first and second engagement members 62, 66 are operatively engageable as described above. By way of a non-limiting example, the engaging plate 68 may include an inner tube engaging portion similar to the attachment member 60 described above. The second engagement member 66 may be positioned on the inner tube engaging portion on the engaging plate 68 and may operate as described above.

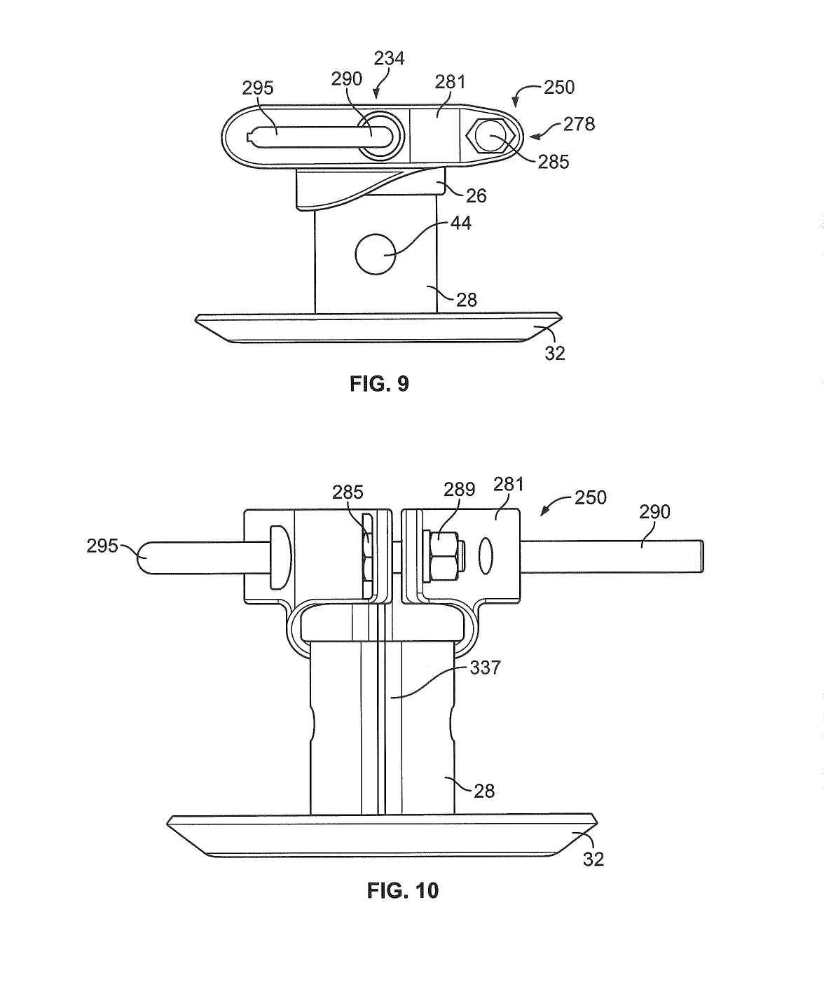

Further still, the jack 20 may include other embodiments of an engagement device 250 as shown in FIGS. 9-12. The engagement device 250 may selectively and operatively engage the drop leg 28 with the inner tube 26 to lock the drop leg 28 in an operative position relative to the inner tube 26. The engagement device 250 may include a pin assembly 254 and self-locating device 258 of any appropriate configuration.

The pin assembly 254 may include an attachment device 278 of any appropriate configuration to operatively couple the engagement device 250 with the inner tube 26. The attachment device 278 may include a strap 281 that may generally circumscribe the inner tube 26 or a portion of the inner tube 26. The strap 281 may be of any appropriate configuration. By way of a non-limiting example, the strap 281 may include a single steel strap that circumscribes at least a portion of the inner tube 26.

The attachment device 278 may include a fastener 285 that is selectively engageable with the strap 281 to tighten the strap 281 with the inner tube 26. The fastener 285 may permit the strap 281 to be operatively attached with inner tubes 26 of different sizes and may account for any potential manufacturing tolerance issues with either of the inner tube 26 and/or the strap 281. The attachment device 278 may include a nut 287 to operatively tighten the fastener 285 with the strap 281. Although, in some embodiments, the fastener 285 may directly engage with the strap 281 without need for a nut 287. Further still, while a single strap 281, fastener 285 and nut 287 are shown it should be understood that any number of straps 281, fasteners 285 and nuts 287 may be utilized without departing from the present teachings. By way of a non-limiting example, a plurality of fasteners 285 and nuts 287 may be used to operatively secure the single strap 281.

The attachment device 278 may further include a pin member 290. The pin member 290 may be of any appropriate shape and size. By way of a non-limiting example, the pin member 290 may include a pair of pin portions 291, 293 and a handle portion 295. The pin portions 291, 293 and handle portion 295 may be monolithically formed as a single unit or may be attached such as through a subsequent operation. As shown the pin member 290 may have a general U-shape with one of the pin portions 291, 293 extending further than the other of the pin portions 291, 293. The handle portion 295 may be formed at the bottom of the U-shaped portion such that it is easy for a user to grasp.

The strap 281 may include two pairs of apertures 296 of any appropriate configuration. The apertures 296 may be of any appropriate shape and positioned at any appropriate location on the strap 281. As shown the first set of apertures 296a may be shaped and sized to operatively receive the pin portion 291 therethrough. The second set of apertures 296b may be shaped and sized to operatively receive the pin portion 293 therethrough. It should be understood, however, that the configuration may also be the opposite, i.e., the first set of apertures 296a may receive the pin portion 293 whereas the second set of apertures 296b may receive the pin portion 291.

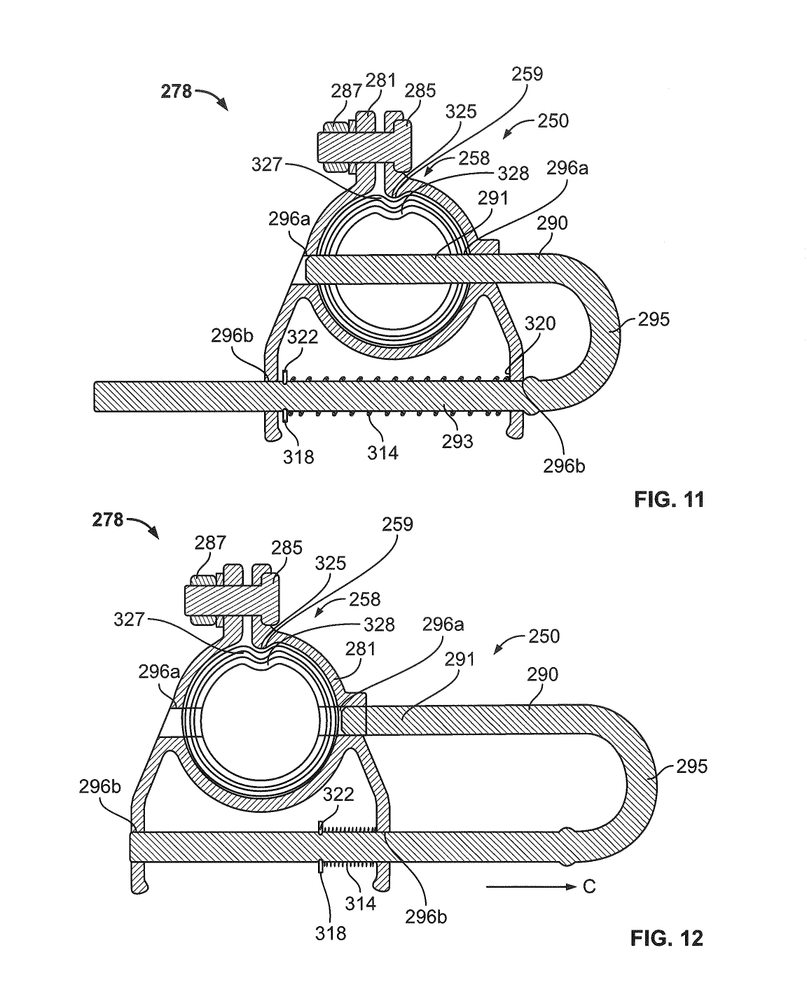

As shown in FIGS. 11 and 12, the pin portion 291 may be of a shape and size such that it is selectively and axially positionable into and out of the apertures 36 and 44 of the inner tube 26 and drop leg 28 as described in more detail below.

The pin portion 293 may be of a shape and size such that it is selectively and axially positionable within or outside of the apertures 296b of the strap 281. The pin assembly 254 may be biased by a biasing member 314 of any appropriate configuration to the engaged position shown in FIG. 11. The biasing member 314 may be operatively engaged with the pin portion 293 and may be generally positioned within the strap 281. The biasing member 314 may include a coiled spring, helical spring, compression spring or the like that generally circumscribes the pin portion 293 as shown in FIGS. 11 and 12, i.e., the biasing member 314 may telescopingly engage the pin portion 293. While the biasing member 314 is shown as a coiled spring circumscribing the pin portion 293, the biasing member 314 may be of any configuration and is not limited to that shown and described herein. In some embodiments, the biasing member 314 may bias the pin portion 293 toward the engaged position such that the pin portion 291 is biased toward the inner tube 26. This may result in the pin portion 291 engaging the apertures 36, 44 of the inner tube 26 and drop leg 28, respectively.

The pin assembly 254 may include a washer 318 that may be attached with the pin portion 293. The washer 318 may be of any appropriate configuration and attached with the pin portion 293 in any appropriate manner, including, without limitation, being fastened, welded, adhered or being monolithically formed therewith. By way of a non-limiting example, a pin (not shown) may be inserted into the pin portion 293, such as through an aperture formed therein, and may engage the washer 318 to position and maintain the washer 318 in an operative position. The washer 318 may include an aperture 322 through which the pin portion 293 may pass. The biasing member 314 may be positioned generally between the washer 318 and an end portion 320 of the strap 281. The distance between the washer 318 and the end portion 320 of the strap 281 may allow the biasing member 314 to be in a generally or partially uncompressed state, i.e., the biasing member 314 biases the pin portion 291 through the pin portion 293 toward the inner tube 26 whereby the pin portion 291 may engage the apertures 36, 44 of the inner tube 26 and drop leg 28, respectively.

It should be understood that the present teachings are not limited to the washer 318. An e-clip, circle clip or the like may be utilized without departing from the present teachings. In such embodiments, the e-clip or circle clip may be operatively positioned on the pin portion 293 and may engage the biasing member 318.

The handle 295 may be of any appropriate shape and size. The handle 295 may assist the user in selectively and axially positioning the pin portions 291, 293 in order to operate the pin assembly 254. Specifically, the handle 295 may be of a configuration to permit the user to easily axially position the pin portions 291, 293 to and from engaged and disengaged positions. By way of a non-limiting example, the user may grasp the handle 295 and axially and selectively position the pin portions 291, 293. The biasing member 314 may be configured to bias the pin portions 291, 293 toward the engaged position. The handle 295 may allow the user to overcome this biasing force and axially pull—such as shown by arrow C in FIG. 12—the portions 291, 293 until the pin portion 291 exits the apertures 36 and 44 of the inner tube 26 and drop leg 28.

As shown and by way of an exemplary embodiment, the self-locating device 258 may include a mating engagement member 259. The mating engagement member 259 may include, without limitation, a bump 325 formed in a portion of the strap 281. The bump 325 may be of a configuration and size to operatively mate with a groove 327 formed in the inner tube 26. A corresponding groove 328 may also be formed in the drop leg 28—see FIG. 11. The groove 327 may be of any configuration and positioned in any appropriate location, including, without limitation on opposing sides 40 of the inner tube 26. As shown in FIGS. 11 and 12, groove 327 may be of a generally semi-circular shape, but may be of any appropriate shape. The bump 325 may be of a configuration such that it mates snugly with the groove 327 as shown in FIGS. 11 and 12. The bump 325 being positioned within the groove 327 may help ensure that the engagement device 250 is operatively positioned on the inner tube 26. The bump 325 may be positioned on a length of the strap 281 or along a portion of a length of the strap 281.

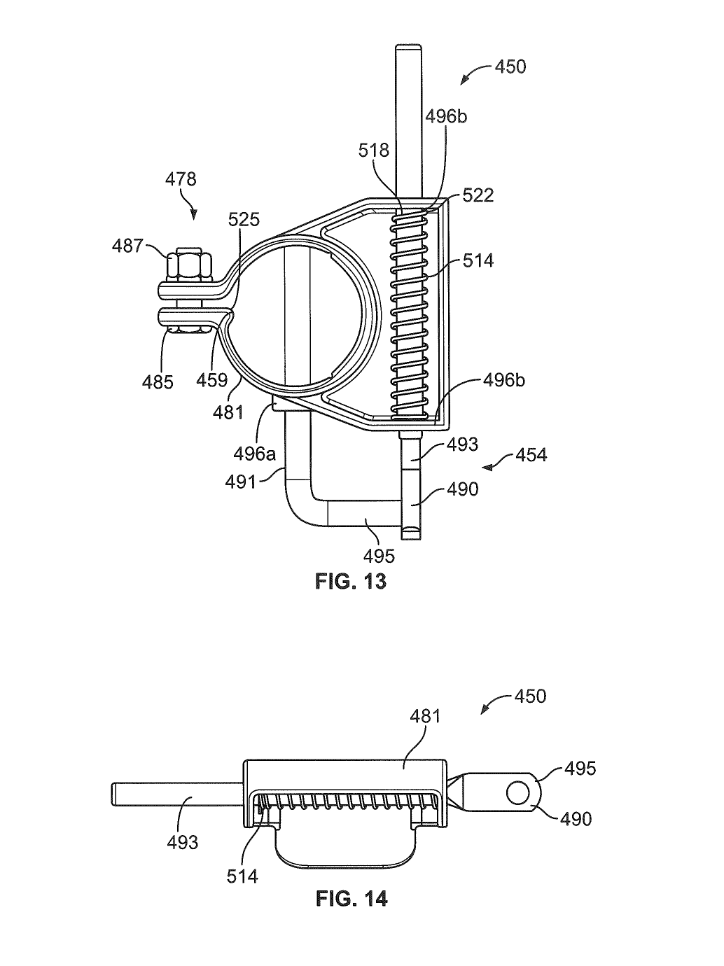

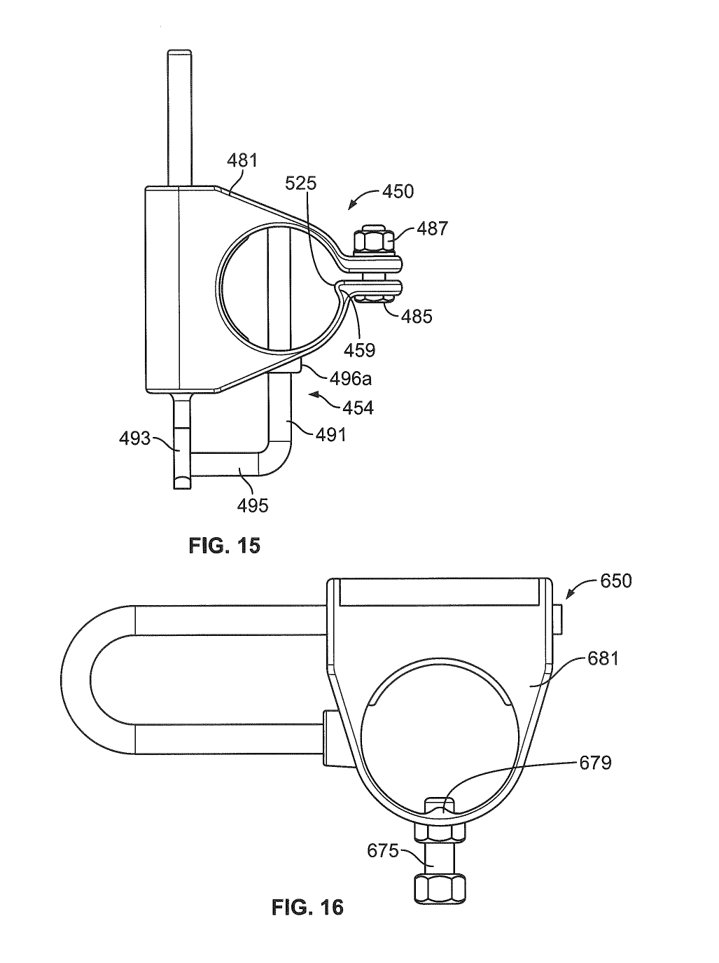

The jack 20 may include other embodiments of an engagement device 450 as shown in FIGS. 13-15. The engagement device 450 may selectively and operatively engage the drop leg 28 with the inner tube 26 to lock the drop leg 28 in an operative position relative to the inner tube 26. The engagement device 450 may include a pin assembly 454 and a self-locating device 458 of any appropriate configuration.

The pin assembly 454 may include an attachment device 478 of any appropriate configuration to operatively couple the engagement device 450 with the inner tube 26. The attachment device 478 may include a strap 481 that may generally circumscribe the inner tube 26 or a portion of the inner tube 26. The strap 481 may be of any appropriate configuration. By way of a non-limiting example, the strap 481 may include a single steel strap that circumscribes at least a portion of the inner tube 26.

The attachment device 478 may include a fastener 485 that is selectively engageable with the strap 481 to tighten the strap 481 with the inner tube 26. The fastener 485 may permit the strap 481 to be operatively attached with inner tubes 26 of different sizes and may account for any potential manufacturing tolerance issues with either of the inner tube 26 and/or the strap 481. The attachment device 478 may include a nut 487 to operatively tighten the fastener 485 with the strap 481. Although, in some embodiments, the fastener 485 may directly engage with the strap 481 without need for a nut 487. Further still, while a single strap 481, fastener 485 and nut 487 are shown it should be understood that any number of straps 481, fasteners 485 and nuts 487 may be utilized without departing from the present teachings. By way of a non-limiting example, a plurality of fasteners 485 and nuts 487 may be used to operatively secure the single strap 481.

The attachment device 478 may further include a pin member 490. The pin member 490 may be of any appropriate shape and size. By way of a non-limiting example, the pin member 490 may include a pair of pin portions 491, 493 and a handle portion 495. The pin portions 491, 493 and handle portion 495 may be attached such as through welding, fastening or the like. As shown the pin member 490 may have a general h-shape with one of the pin portions 491, 493 extending further than the other of the pin portions 491, 493. The handle portion 495 may be formed to make it easy for a user to grasp.

The strap 481 may include apertures 496 of any appropriate configuration. The apertures 496 may be of any appropriate shape and positioned at any appropriate location on the strap 481. As shown the first aperture 496a may be shaped and sized to operatively receive the pin portion 491. A second set of apertures 496b may be shaped and sized to operatively receive the pin portion 493 therethrough. It should be understood, however, that the configuration may also be the opposite, i.e., the first aperture 496a may receive the pin portion 493 whereas the second set of apertures 496b may receive the pin portion 491.

The pin portion 491 may be of a shape and size such that it is selectively and axially positionable into and out of the apertures 36 and 44 of the inner tube 26 and drop leg 28 as described in more detail below.

The pin portion 493 may be of a shape and size such that it is selectively and axially positionable within or outside of the apertures 496b of the strap 481. The pin assembly 454 may be biased by a biasing member 514 of any appropriate configuration to the engaged position shown in FIG. 13. The biasing member 514 may be operatively engaged with the pin portion 493 and may be generally positioned within the strap 481. The biasing member 514 may include a coiled spring, helical spring, compression spring or the like that generally circumscribes the pin portion 493 as shown in FIG. 13, i.e., the biasing member 514 may telescopingly engage the pin portion 493. While the biasing member 514 is shown as a coiled spring circumscribing the pin portion 493, the biasing member 514 may be of any configuration and is not limited to that shown and described herein. In some embodiments, the biasing member 514 may bias the pin portion 493 toward the engaged position such that the pin portion 491 is biased toward the inner tube 26. This may result in the pin portion 491 engaging the apertures 36, 44 of the inner tube 26 and drop leg 28, respectively.

The pin assembly 454 may include a washer 518 that may be attached with the pin portion 493. The washer 518 may be of any appropriate configuration and may be attached with the pin portion 493 in any appropriate manner, including, without limitation, being fastened, welded, adhered or being monolithically formed therewith. By way of a non-limiting example, a pin (not shown) may be inserted into the pin portion 493, such as through an aperture formed therein, and may engage the washer 518 to position and maintain the washer 518 in an operative position. The washer 518 may include an aperture 522 through which the pin portion 493 may pass. The biasing member 514 may be positioned generally between the washer 518 and an end portion 520 of the strap 481. The distance between the washer 518 and end portion 520 of the strap 481 may allow the biasing member 514 to be in a generally or partially uncompressed state, i.e., the biasing member 514 biases the pin portion 491 through the pin portion 493 toward the inner tube 26 whereby the pin portion 491 may engage the apertures 36, 44 of the inner tube 26 and drop leg 28, respectively.

It should be understood that the present teachings are not limited to the washer 518. An e-clip, circle clip or the like may be utilized without departing from the present teachings. In such embodiments, the e-clip or circle clip may be operatively positioned on the pin portion 493 and may engage the biasing member 518.

The handle 495 may be of any appropriate shape and size. The handle 495 may assist the user in selectively and axially positioning the pin portions 491, 493 in order to operate the pin assembly 454. Specifically, the handle 495 may be of a configuration to permit the user to easily such to axially position the pin portions 491, 493 to and from engaged and disengaged positions. By way of a non-limiting example, the user may grasp the handle 495 and axially and selectively position the pin portions 491, 493. The biasing member 514 may be configured to bias the pin portions 491, 493 toward the engaged position. The handle 495 may allow the user to overcome this biasing force and axially pull the portions 491, 493 until the pin portion 491 exits the apertures 36 and 44 of the inner tube 26 and drop leg 28.

As shown and by way of an exemplary embodiment, the self-locating device 458 may include a mating engagement member 459 to operatively engage with the drop leg 28. The mating engagement member 459 may include, without limitation, a bump 525 formed in a portion of the strap 481—the bump 525 may be monolithically formed or attached through a subsequent operation. The bump 525 may be of a configuration and size to operatively mate with a groove 327 formed in the inner tube 26. The groove 327 may be of any configuration and positioned in any appropriate location, including, without limitation on the opposing sides 40 of the inner tube 26. The bump 525 may be of a configuration such that it mates snugly with the groove 327 as shown in FIGS. 11 and 12. The bump 525 being positioned within the groove 327 may help ensure that the engagement device 450 is operatively positioned on the inner tube 26. The bump 525 may be positioned on a length of the strap 481 or along a portion of a length of the strap 481.

The embodiments of an engagement device 650 depicted in FIG. 16 may be similar to the engagement devices 250 and 450. However, instead of including the bump 525 engaging the groove 327, the engagement device 650 may utilize a set screw 675 that may selectively and operatively engage with the inner tube 26 or more specifically the groove 327 in the inner tube 26. It should be understood, however, that the set screw 675 may engage a side portion of the inner tube 26 absent the groove 327 or with the groove 327. Further, the engagement device 650 may include an aperture 679 formed in a strap 681. The aperture 679 may be shaped and sized to permit axial movement of the set screw 675 with respect to the strap 681 to selectively engage with and disengage from the inner tube 26.

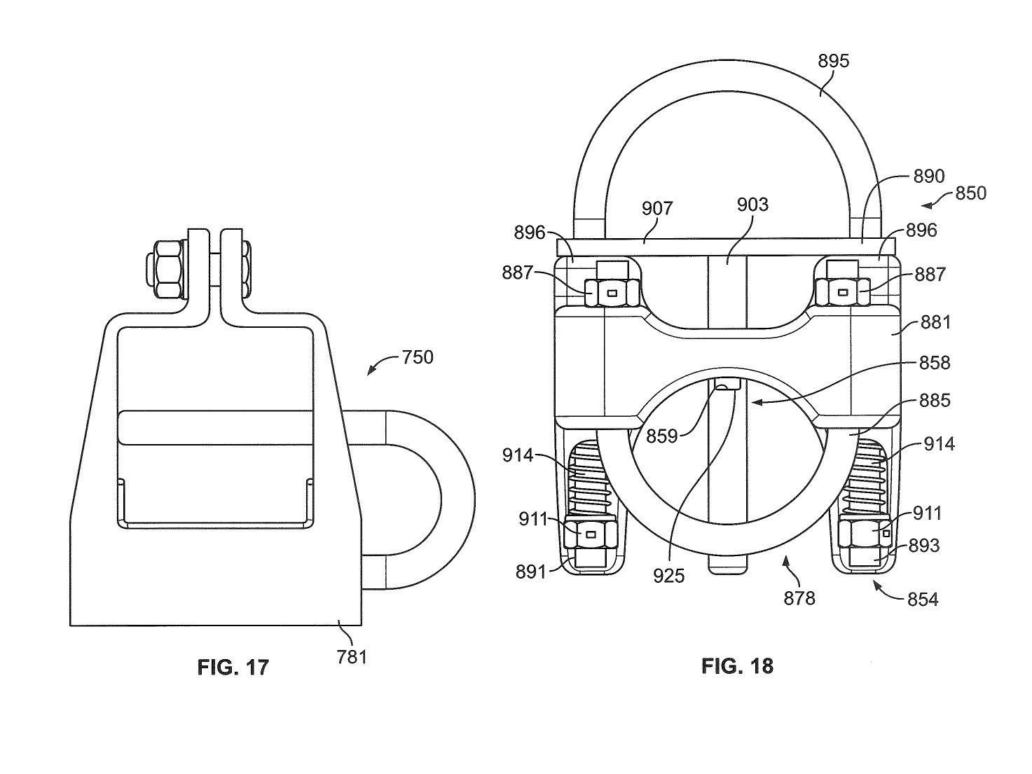

The embodiments of an engagement device 750 depicted in FIG. 17 may be similar to the engagement devices 250 and 450. However, instead of including a generally round strap that circumscribes a generally round inner tube, the engagement device 750 includes a generally rectangular (or for example a square) strap 781 that is engageable with and can generally circumscribe a generally rectangular (or for example a square) inner tube. These embodiments may be used with generally square jack tubes—especially heavy duty jacks.

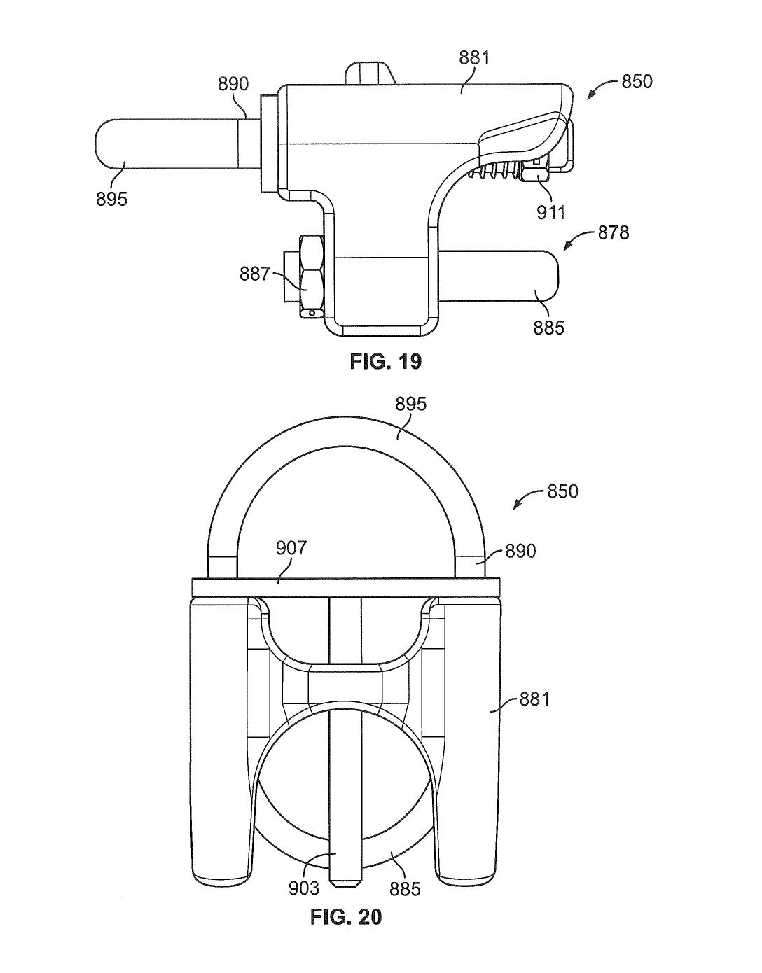

Embodiments of an engagement device 850 are shown in FIGS. 18-20. The engagement device 850 may selectively and operatively engage the drop leg 28 with the inner tube 26 to lock the drop leg 28 in an operative position relative to the inner tube 26. The engagement device 850 may include a pin assembly 854 and a self-locating device 858 of any appropriate configuration.

The pin assembly 854 may include an attachment device 878 of any appropriate configuration to operatively couple the engagement device 850 with the inner tube 26. The attachment device 878 may include a strap 881 that may generally circumscribe a portion of the inner tube 26 or a portion of the inner tube 26. The strap 881 may be of any appropriate configuration. By way of a non-limiting example, the strap 881 may include a single steel strap that circumscribes at least a portion of the inner tube 26.

The attachment device 878 may include a generally U-shaped fastener 885 that is selectively engageable with the strap 881 to tighten the strap 881 with the inner tube 26. The fastener 885 may permit the strap 881 to be operatively attached with inner tubes 26 of different sizes and may account for any potential manufacturing tolerance issues with either of the inner tube 26 and/or the strap 881. The attachment device 878 may include a nut 887 to operatively tighten the fastener 885 with the strap 881. In some embodiments, such as when the fastener 885 is a generally U-shaped member, a pair of nuts 887, one on each side of the fastener 885, may be utilized. In these embodiments, a portion of the U-shaped fastener 885 may circumscribe the inner tube 26 while a portion of the strap 881 may circumscribe a remaining portion of the inner tube 26. This may result in the strap 881 and the fastener 885 circumscribing all of the inner tube 26.

The attachment device 878 may further include a pin member 890. The pin member 890 may be of any appropriate shape and size. By way of a non-limiting example, the pin member 890 may include a pair of pin portions 891, 893 and a handle portion 895. The pin portions 891, 893 and handle portion 895 may be monolithically formed or formed through a subsequent operation. As shown the pin member 890 may have a general U-shape. The handle portion 895 may be formed to make it easy for a user to grasp. The pin member 890 may further include a third pin portion 903 that is generally positioned between the pin portions 891 and 893. A transverse member 907 may be utilized to attach the pin portions 891 and 893 with the third pin portion 903. These components may be monolithically formed or formed through a subsequent operation such as welding or the like.

The strap 881 may include a pair of apertures 896 of any appropriate configuration. The apertures 896 may be of any appropriate shape and positioned at any appropriate location on the strap 881. As shown in FIG. 18 the apertures 896 may be shaped and sized to operatively receive the pin portions 891, 893 therethrough.

The strap 881 may include another aperture or slot through which the third pin portion 903 is axially positionable relative thereto. The third pin portion 903 may be of a shape and size such that it is selectively and axially positionable into and out of the apertures 36 and 44 of the inner tube 26 and drop leg 28 as described in more detail below

The third pin portion 903 may be of a shape and size such that it is selectively and axially positionable within or outside of the aperture or slot of the strap 881 positioned in a general middle portion thereof. The pin assembly 854 may be biased by a biasing member 914, or as shown in the drawings a pair of biasing members 914, of any appropriate configuration to the engaged position shown in FIGS. 18 and 20. The biasing members 914 may be operatively engaged with the pin portions 891, 893 and may be generally positioned within the strap 881. The biasing members 914 may include a coiled spring, helical spring, compression spring or the like that generally circumscribes the pin portions 891, 893 as shown in FIG. 18, i.e., the biasing members 914 may telescopingly engage the pin portions 891, 893. While the biasing members 914 are shown as coiled springs circumscribing the pin portions 891, 893, the biasing members 914 may be of any configuration and is not limited to that shown and described herein. In some embodiments, the biasing members 914 may bias the third pin portion 903 toward the engaged position such that the third pin portion 903 is biased toward the inner tube 26. This may result in the third pin portion 903 engaging the apertures 36, 44 of the inner tube 26 and drop leg 28, respectively.

The pin assembly 854 may include a pair of nuts 911 that may be attached with the pin portions 891, 893. The nuts 911 may be of any appropriate configuration and may be attached with the pin portions 891, 893 in any appropriate manner, including, without limitation, being threaded thereto. The biasing members 914 may be positioned generally between the nuts 911 and end portions of the strap 881 in proximity to the apertures 896. The distance between the nuts 911 and end portion of the strap 881 may allow the biasing members 914 to be in a generally or partially uncompressed state, i.e., the biasing members 914 bias the pin portions 891, 893, which bias the third pin portion 903 toward the inner tube 26 whereby the third pin portion 903 may engage the apertures 36, 44 of the inner tube 26 and drop leg 28, respectively.

The handle 895 may be of any appropriate shape and size. The handle 895 may assist the user in selectively and axially positioning the pin portions 891, 893 and third pin portion 903 in order to operate the pin assembly 854. Specifically, the handle 895 may be of a configuration to permit the user to easily such to axially position the pin portions 891, 893 and the third pin portion 903 to and from engaged and disengaged positions. By way of a non-limiting example, the user may grasp the handle 895 and axially and selectively position the pin portions 891, 893. The biasing member 914 may be configured to bias the pin portions 891, 893 toward the engaged position. The handle 895 may allow the user to overcome this biasing force and axially pull the portions 891, 893 until the third pin portion 903 exits the apertures 36 and 44 of the inner tube 26 and drop leg 28.

As shown and by way of an exemplary embodiment, the self-locating device 858 may include a mating engagement member 859. The mating engagement member 859 may include, without limitation, a tab 925 formed in a portion of the strap 881—the tab 925 may be monolithically formed or attached through a subsequent operation. The tab 925 may be of a configuration and sized to operatively mate with a groove 327 formed in the inner tube 26. The groove 327 may be of any configuration and positioned in any appropriate location, including, without limitation on the opposing sides 40 of the inner tube 26. The tab 925 may be of a configuration such that it mates snugly with the groove 327. The tab 925 being positioned within the groove 327 may help ensure that the engagement device 850 is operatively positioned on the inner tube 26.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A jack comprising:
a first tube member;
a second tube member telescopingly engaged with the first tube member, the second tube member including at least one aperture;
a drop leg telescopingly engaged with the second tube member; and
an engagement device operatively coupled with the second tube member, the engagement device including a pin member and a self-locating device, wherein the self-locating device generally aligns the pin member with the at least one aperture of the second tube member.

2. The jack of claim 1, wherein the engagement device includes an attachment member and housing member operatively attached with each other.

3. The jack of claim 2, wherein the pin member is partially housed within the housing member.

4. The jack of claim 1, wherein the pin member includes a locking member whereby the locking member engages the pin member in at least one of an engaged position and disengaged position.

5. The jack of claim 4, wherein the pin member is rotatable to engage the locking member with a portion of the engagement device generally maintaining the pin member in at least one of the engaged and disengaged positions.

6. The jack of claim 1, wherein the first and second tube members have a generally round cross-sectional shape.

7. The jack of claim 1, wherein the first and second tube members have a generally square cross-sectional shape.

8. The jack of claim 1, wherein the self-locating device includes an engagement member configured to engage a portion of the drop leg.

9. The jack of claim 8, wherein the drop leg includes a slot and the engagement member includes a bump engaged with the slot of the drop leg.

10. The jack of claim 1, wherein the engagement device includes a strap generally circumscribing a portion of the drop leg.

11. The jack of claim 10, wherein the self-locating device includes a bump formed in the strap, the bump engageable with the drop leg.

12. A jack comprising:
a pair of telescoping tubular members, at least one of the pair of telescoping tubular members including at least one aperture;
a drop leg telescopingly engaged with the at least one of the pair of telescoping tubular members; and
an engagement device selectively attached with the drop leg, the engagement device comprising:
a pin assembly selectively engageable with the drop leg; and
a self-locating device that generally aligns the pin assembly with the at least one aperture of the at least one of the pair of telescoping tubular members.

13. The jack of claim 12, wherein the pin assembly includes a strap selectively engaged with the drop leg.

14. The jack of claim 13, wherein the self-locating device is positioned on the strap.

15. The jack of claim 14, wherein the self-locating device comprises a bump formed on the strap.

16. The jack of claim 15, wherein the drop leg includes a slot and the bump engages the slot to generally align a pin of the pin assembly with the at least one aperture of the at least one of the pair of telescoping tubular members.

17. The jack of claim 16, wherein the pin is biased toward the at least one of the pair of telescoping tubular members.

18. A jack comprising:
a first tube member;
a second tube member telescopingly engaged with the first tube member, the second tube member including at least one aperture;
a drop leg telescopingly engaged with the second tube member; and
an engagement device comprising:
a pin member axially positionable to engage the at least one aperture of the second tube member; and
a strap selectively engaged with the drop leg, the strap including a self-locating device engageable with the drop leg to operatively position the pin member with respect to the at least one aperture.

19. The jack of claim 18, wherein the self-locating device includes a bump formed in the strap.

20. The jack of claim 18, wherein the strap selectively circumscribes a portion of the drop leg.

21. The jack of claim 20, further comprising a fastener attaching the strap with the drop leg.

22. The jack of claim 18 further comprising a biasing member biasing the pin member toward the drop leg.

23. The jack of claim 22, wherein the biasing member includes a spring circumscribing the pin member.

24. A jack comprising:
a pair of telescoping tubular members, at least one of the pair of telescoping tubular members including at least one aperture;
a drop leg telescopingly engaged with the at least one of the pair of telescoping tubular members, the drop leg including at least one drop leg aperture; and
an engagement device engaged with the drop leg, the engagement device comprising:
a pin member axially positionable from an engaged position to a disengaged position; and
a strap engaged with the drop leg, the strap holding the pin member when the pin member is in the disengaged position.

25. The jack of claim 24, wherein the pin member in the engaged position engages the at least one aperture of the at least one of the pair of telescoping tubular members and the drop leg aperture of the drop leg.

26. The jack of claim 25, wherein the at least one aperture of the least one of the pair of telescoping tubular members includes a pair of apertures on opposed sides and the at least one drop leg apertures includes a pair of drop leg apertures on opposed sides of the drop leg, whereby the pin member in the engaged position engages the pair of apertures of the at least one of the pair of telescoping tubular members and the pair of drop leg apertures of the drop leg.

27. The jack of claim 26, wherein the pin member in the disengaged position is free of engagement with the pair of apertures of the at least one of the pair of telescoping tubular members and the pair of drop leg aperture of the drop leg.

28. The jack of claim 27, wherein the pin member in the disengaged position is maintained in an operative position with respect to the drop leg.

29. The jack of claim 24, wherein the pin member in the disengaged position is free of engagement with the at least one aperture of the at least one of the pair of telescoping tubular members and the drop leg aperture of the drop leg.

30. The jack of claim 24, wherein the pin member is biased toward the drop leg.

31. The jack of claim 24, wherein the strap is selectively engaged with the drop leg.

32. The jack of claim 24, wherein the pin member in the disengaged position is maintained in a generally horizontal position relative to the drop leg.

33. The jack of claim 24, wherein the pin member in the disengaged position is maintained in an operative position with respect to the drop leg.
